(19) United States
(12) Patent Application Publication
(10) Pub. No.: US 2023/0085500 A1
(43) Pub. Date: Mar. 16, 2023

(54) METHOD, APPARATUS, AND COMPUTER PROGRAM PRODUCT FOR POINT-OF-INTEREST RECOMMENDATIONS

(71) Applicant: HERE GLOBAL B.V., Eindhoven (NL)

(72) Inventor: Soojung Hong, Zurich (CH)

(21) Appl. No.: 17/447,350

(22) Filed: Sep. 10, 2021

(51) Int. Cl. G06F 16/2457; G06F 16/29; G06N 20/00

(52) U.S. Cl. CPC G06F 16/24575; G06F 16/24578; G06F 16/29; G06N 20/00

(57) ABSTRACT

Provided herein is a method, apparatus, and computer program product for generating and using a query context space to measure and quantify recommendations for points-of-interest. Methods may include: receiving a query for a point-of-interest; parsing the query and extracting contexts from the query; constructing a query context space with each extracted context including a dimension of the query context space; identifying points-of-interest satisfying a predetermined criterion; mapping the points-of-interest to the query context space; and determining recommendations for the points-of-interest mapped to the query context space based on a distance of a respective point-of-interest from an origin of the query context space. Methods may include providing for display of a list of recommendations for the points-of-interst mapped to the query context space ranked from closest to the origin of the query context space to furthest from the origin.

### TECHNOLOGICAL FIELD

Example embodiments described herein relate generally to generating recommendations for points-of-interest, and more particularly, to generating and using a query context space to measure and quantify recommendations for points-of-interest.

### BACKGROUND

Establishing recommendations for users based on a query is a subjective process that may or may not be of help to a user. Recommendation engines often rely on popularity of points-of-interest, through user reviews or vehicle/pedestrian traffic to determine if the point-of-interest is well-liked. A high volume of vehicle and/or pedestrian traffic at a particular point-of-interest may suggest that the point-of-interest is very popular and well-liked. Recommendations may further be based on location including a proximity to a requesting user. Developing a good recommendation model is challenging as there is no correct or incorrect recommendation. Rather, there are good and bad recommendations. Because of the nature of ambiguity in user queries, it is difficult to extract user intentions within user queries. Further, it is often difficult to retrieve sufficient user feedback on previous recommendations to determine if the recommendations are or were good. With a lack of user feedback on recommendations that have been made, the recommendation engines may keep the same mechanism to select the point-of-interest recommendations, even if the recommended point-of-interests are mediocre. Therefore, the recommended points-of-interest of a map service may fail to satisfy user expectations.

Recommendation techniques can include collaborative filtering or matrix factorization; however, these techniques require large amounts of user interaction logs or user preference records to build a data structure that these techniques require. User profile data and user service interaction logs are often unavailable or insufficient to generate satisfactory recommendations. Thus, the recommendation engines that use these recommendation techniques without sufficient user interaction logs or user profile data may result in recommendations that are out of context or seemingly random to a user.

### BRIEF SUMMARY OF EXAMPLE EMBODIMENTS

At least some example embodiments are directed to generally to generating recommendations for points-of-interest, and more particularly, to generating and using a query context space to measure and quantify recommendations for points-of-interest. Embodiments may provide an apparatus including at least one processor and at least one memory including computer program code, the at least one memory and the computer program code may be configured to, with the processor, cause the apparatus to at least: receive a query for point-of-interest recommendations; parse the query and extract contexts from the query; construct a query context space with each extracted context comprising a dimension of the query context space; identify points-of-interest satisfying a predetermined criterion; map the points-of-interest to the query context space; and determine recommendations for the points-of-interest mapped to the query context space based on a distance of a respective point-of-interest from an origin of the query context space.

According to some embodiments, the apparatus is further caused to provide for display of a list of recommendations for the points-of-interest mapped to the query context space ranked from closest to the origin of the query context space to furthest from the origin. The predetermined criterion includes at least one of a predefined boundary or a predefined distance from a location associated with the query. Causing the apparatus of some embodiments to parse and extract contexts from the query includes causing the apparatus to process the query using a machine learning algorithm to extract contexts from the query. The extracted contexts from the query include, in some embodiments, a semantic similarity, a distance from a location associated with the query, and a rating or popularity of a point-of-interest.

Causing the apparatus of some embodiments to map the points-of-interest to the query context space includes causing the apparatus to: determine, for each identified point-of-interest, a semantic similarity to the query; determine, for each identified point-of-interest, a distance to the location associated with the query; and determine, for each identified point-of-interest, a rating. Causing the apparatus of some embodiments to map the points-of-interest to the query context space further includes causing the apparatus to: calculate a vector for each point-of-interest based on the respective semantic similarity, the distance, and the rating; and determine a length of the vector for each point-of-interest. Causing the apparatus of some embodiments to determine recommendations for the points-of-interest mapped to the query context space based on a distance of a respective point-of-interest from an origin of the query context space includes causing the apparatus to rank the points-of-interest based on the length of the vector for each point-of-interest, where a shorter length of the vector corresponds to a higher ranking.

Embodiments provided herein include a computer program product including at least one non-transitory computer-readable storage medium having computer executable program code instructions stored therein, the computer-executable program code instructions including program code instructions to: receive a query for point-of-interest recommendations; parse the query and extract contexts from the query; construct a query context space with each extracted context comprising a dimension of the query context space; identify points-of-interest satisfying a predetermined criterion; map the points-of-interest to the query context space; and determine recommendations for the points-of-interest mapped to the query context space based on a distance of a respective point-of-interest from an origin of the query context space.

The computer program product of some embodiments include program code instructions to provide for display of a list of recommendations for the points-of-interest mapped to the query context space ranked from closest to the origin of the query context space to furthest from the origin. The predetermined criterion includes at least one of a predefined boundary or a predefined distance from a location associated with the query. The program code instructions to parse and extract contexts from the query include program code instructions to process the query using a machine learning algorithm to extract contexts from the query. The extracted contexts from the query of some embodiments include a semantic similarity, a distance from a location associated with the query, and a rating.

According to some embodiments, the program code instructions to map the points-of-interest to the query context space include program code instructions to: determine, for each identified point-of-interest, a semantic similarity to the query; determine, for each identified point-of-interest, a distance to the location associated with the query; and determine, for each identified point-of-interest, a rating. The program code instructions to map the points-of-interest to the query context space include, in some embodiments, program code instructions to: calculate a vector for each point-of-interest based on the respective semantic similarity, the distance, and the rating; and determine a length of the vector for each point-of-interest. Causing the apparatus of some embodiments to determine recommendations for the points-of-interest mapped to the query context space based on a distance of a respective point-of-interest from an origin of the query context space include program code instructions to rank the points-of-interest based on the length of the vector for each point-of-interest, where a shorter length of the vector corresponds to a higher ranking.

Embodiments provided herein include a method including: receiving a query for point-of-interest recommendations; parsing the query and extracting contexts from the query; constructing a query context space with each extracted context including a dimension of the query context space; identifying points-of-interest satisfying a predetermined criterion; mapping the points-of-interest to the query context space; and determining recommendations for the points-of-interest mapped to the query context space based on a distance of a respective point-of-interest from an origin of the query context space. Methods may include providing for display of a list of recommendations for the points-of-interst mapped to the query context space ranked from closest to the origin of the query context space to furthest from the origin. The predetermined criterion optionally includes at least one of a predefined boundary or a predefined distance from a location associated with the query. Parsing and extracting contexts from the query includes, in some embodiments, processing the query using a machine learning algorithm to extract contexts from the query.

Embodiments provided herein include an apparatus including: means for receiving a query for point-of-interest recommendations; means for parsing the query and extracting contexts from the query; means for constructing a query context space with each extracted context including a dimension of the query context space; identifying points-of-interest satisfying a predetermined criterion; means for mapping the points-of-interest to the query context space; and means for determining recommendations for the points-of-interest mapped to the query context space based on a distance of a respective point-of-interest from an origin of the query context space. Example apparatuses may include means for providing for display of a list of recommendations for the points-of-interst mapped to the query context space ranked from closest to the origin of the query context space to furthest from the origin. The predetermined criterion optionally includes at least one of a predefined boundary or a predefined distance from a location associated with the query. The means for parsing and extracting contexts from the query includes, in some embodiments, means for processing the query using a machine learning algorithm to extract contexts from the query.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a block diagram showing an example architecture of an example embodiment described herein;

FIG. 2 is a block diagram of an apparatus that may be specifically configured in accordance with an example embodiment of the present disclosure;

FIG. 3 illustrates the extraction of hidden context from queries according to an example embodiment of the present disclosure;

FIG. 4 illustrates the generation of a query context space based on the extracted context of a query according to an example embodiment of the present disclosure;

FIG. 5 illustrates the mapping of points-of-interest within a query context space according to an example embodiment of the present disclosure;

FIG. 6 illustrates a three-dimensional query context space according to an example embodiment of the present disclosure;

FIG. 7 illustrates the three-dimensional query context space of FIG. 6 with a point-of-interest vector according to an example embodiment of the present disclosure;

FIG. 8 illustrates the parsing of points-of-interest to establish semantic context of the points-of-interest according to an example embodiment of the present disclosure;

FIG. 9 illustrates point-of-interest description generation from point-of-interest name and establishing a semantic similarity score for a query according to an example embodiment of the present disclosure;

FIG. 10 illustrates the calculation of a semantic similarity distance from a semantic similarity score according to an example embodiment of the present disclosure;

FIG. 11 illustrates a query context space including a point-of-interest vector and component thereof according to an example embodiment of the present disclosure;

FIG. 12 illustrates a query context space including a plurality of points-of-interest clustered according to an example embodiment of the present disclosure; and

FIG. 13 is a flowchart of a method for generating and using a query context space to measure and quantify recommendations for points-of-interest according to an example embodiment of the present disclosure.

### DETAILED DESCRIPTION OF SOME EXAMPLE EMBODIMENTS

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Methods, apparatus and computer program products are provided in accordance with an example embodiment in order to generally to generating recommendations for points-of-interest, and more particularly, to generating and using a query context space to measure and quantify recommendations for points-of-interest. The query context space does not exist prior to a query, and the query context space is dependent upon the query. Embodiments described herein provide a query context space where a query and recommendable places or “candidate” points-of-interest (POI) are placed. In the query context space of example embodiments, the proximity or measure between a query and a candidate POI can be quantified. The closer a candidate POI is to the query, which is the origin in the query context space described herein, the more recommendable the candidate POIs become. Using this technique, a ranking of recommended places can be determined automatically through the quantified proximity of the candidate POI to the query. The query context space is an n-dimensional space with n number of components. For ease of illustration, embodiments described herein use a 3-dimensional query context space that includes three components that include semantic similarity, popularity, and spatial distance. The origin of the query context space is the query itself. However, as will be appreciated, the number of n-dimensions is not limited to three dimensions.

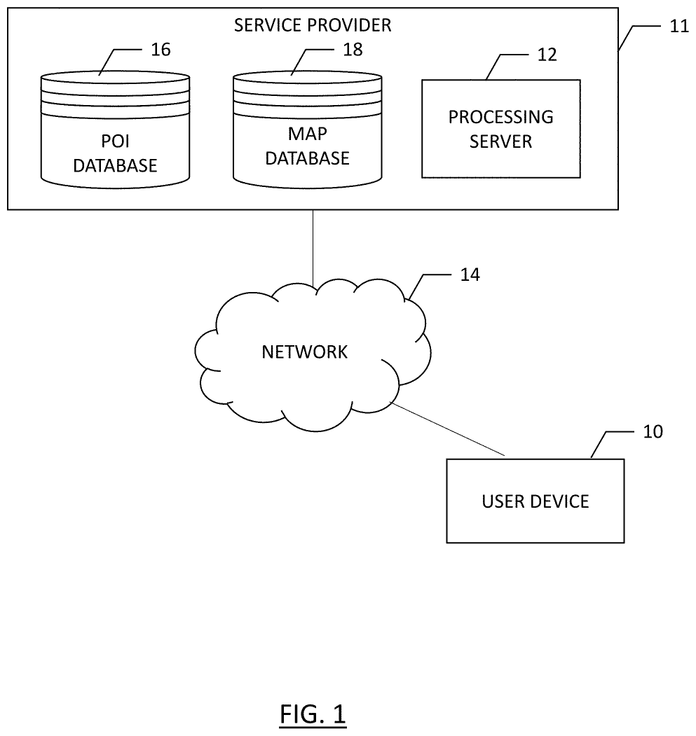

To generate recommendations for points-of-interest using a query context space measuring and quantifying recommendations, a system as illustrated in FIG. 1 may be used. FIG. 1 illustrates a communication diagram of an example embodiment of a system for implementing example embodiments described herein. The illustrated embodiment of FIG. 1 includes a service provider 11, a processing server 12, a map database 18, and a POI database 16. As shown, the service provider 11 may be in communication via a network 14, such as a wide area network, such as a cellular network, the Internet, or a local area network. However, the service provider 11 may be in communication with the other elements of the system in other manners, such as via direct connection through direct communications between the map services provider 11 and data sources.

Examples of the probe data sources as described herein include a user device 10 associated with a user. The user device 10 may be embodied by a number of different devices including mobile computing devices, such as a personal digital assistant (PDA), mobile telephone, smartphone, laptop computer, tablet computer, vehicle navigation system, infotainment system, in-vehicle computer, personal computer, or any combination of the aforementioned.

The processing server 12 of the service provider 11 may also be embodied by a computing device and, in one embodiment, is embodied by a web server. Additionally, while the system of FIG. 1 depicts a single service provider 11 and a single user device 10, systems of example embodiments may include any number of service providers, mobile devices, any number of databases (including map databases, POI databases, or other data repositories), and any number of processing servers, which may operate independently or collaborate to support activities of the embodiments described herein.

The map database 18 may include one or more databases and may include information such as geographic information relating to road networks, points-of-interest, buildings, etc. Further, the map database 18 may store therein historical dynamic population or mobility data, such as historical traffic data, mobile device data, monitored area data (e.g., closed-circuit television), or the like. Thus, the map database 18 may be used to facilitate the quantifying and measuring of human mobility within defined geographic regions and sub-regions to establish familiarity with a geographic region.

The point-of-interest database 16 may include information pertaining to any or all buildings, businesses, tourist attractions, restaurants, memorials, parks, or any type of place a user may seek out to visit. The information may include location, operating hours, user reviews, type of POI (e.g., specific cuisine for a restaurant, specific type of retail store, etc.), POI summary, POI website, POI contact information, POI licensing information, etc. The POI database may thus include any information that may relate to POIs and may be updated periodically by the POIs themselves (e.g., a business owner changing store hours, or a restaurant owner changing menus) or updated based on a data harvesting operation that crawls publicly available information to obtain updates.

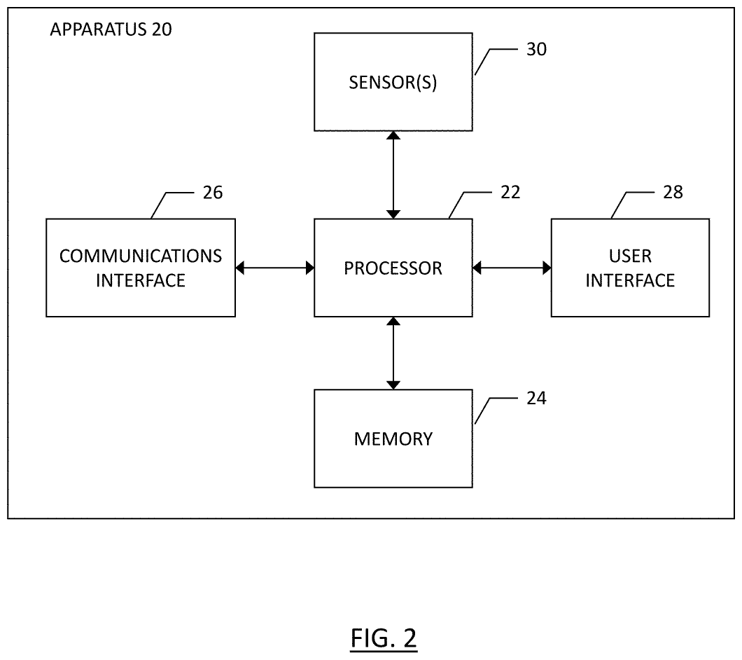

Regardless of the type of device that embodies the local user device 10, the user device may be embodied as an apparatus 20 as shown in FIG. 2. In this regard, the apparatus 20 may include or otherwise be in communication with a processor 22, a memory device 24, a communication interface 26 and a user interface 28. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 22 (and/or co-processors or any other processing circuitry assisting or otherwise associated with the processor) may be in communication with the memory device 24 via a bus for passing information among components of the apparatus. The memory device 24 may include, for example, one or more volatile and/or non-volatile memories. In other words, for example, the memory device 24 may be an electronic storage device (e.g., a computer readable storage medium) comprising gates configured to store data (e.g., bits) that may be retrievable by a machine (e.g., a computing device like the processor). The memory device 24 may be configured to store information, data, content, applications, instructions, or the like for enabling the apparatus 20 to carry out various functions in accordance with an example embodiment of the present invention. For example, the memory device 24 could be configured to buffer input data for processing by the processor 22. Additionally or alternatively, the memory device could be configured to store instructions for execution by the processor.

The processor 22 may be embodied in a number of different ways. For example, the processor 22 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor 22 may include one or more processors configured in tandem via the bus to enable independent execution of instructions, pipelining and/or multithreading.

In an example embodiment, the processor 22 may be configured to execute instructions stored in the memory device 24 or otherwise accessible to the processor 22. Alternatively or additionally, the processor 22 may be configured to execute hard coded functionality. As such, whether configured by hardware or software methods, or by a combination thereof, the processor 22 may represent an entity (e.g., physically embodied in circuitry) capable of performing operations according to an embodiment of the present invention while configured accordingly. Thus, for example, when the processor 22 is embodied as an ASIC, FPGA or the like, the processor 22 may be specifically configured hardware for conducting the operations described herein. Alternatively, as another example, when the processor 22 is embodied as an executor of software instructions, the instructions may specifically configure the processor 22 to perform the algorithms and/or operations described herein when the instructions are executed. However, in some cases, the processor 22 may be a processor of a specific device (e.g., a head-mounted display) configured to employ an embodiment of the present invention by further configuration of the processor 22 by instructions for performing the algorithms and/or operations described herein. The processor 22 may include, among other things, a clock, an arithmetic logic unit (ALU) and logic gates configured to support operation of the processor 22. In one embodiment, the processor 22 may also include user interface circuitry configured to control at least some functions of one or more elements of the user interface 28.

Meanwhile, the communication interface 26 may include various components, such as a device or circuitry embodied in either hardware or a combination of hardware and software that is configured to receive and/or transmit data between a computing device (e.g. user device 10) and a processing server 12. In this regard, the communication interface 26 may include, for example, an antenna (or multiple antennas) and supporting hardware and/or software for enabling communications wirelessly. Additionally or alternatively, the communication interface 26 may include the circuitry for interacting with the antenna(s) to cause transmission of signals via the antenna(s) or to handle receipt of signals received via the antenna(s). For example, the communications interface 26 may be configured to communicate wirelessly with a head-mounted display, such as via Wi-Fi (e.g., vehicular Wi-Fi standard 802.11p), Bluetooth, mobile communications standards (e.g., 3G, 4G, or 5G) or other wireless communications techniques. In some instances, the communication interface 26 may alternatively or also support wired communication. As such, for example, the communication interface 26 may include a communication modem and/or other hardware/software for supporting communication via cable, digital subscriber line (DSL), universal serial bus (USB) or other mechanisms. For example, the communication interface 26 may be configured to communicate via wired communication with other components of a computing device.

The user interface 28 may be in communication with the processor 22, such as the user interface circuitry, to receive an indication of a user input and/or to provide an audible, visual, mechanical, or other output to a user. As such, the user interface 28 may include, for example, a keyboard, a mouse, a joystick, a display, a touch screen display, a microphone, a speaker, and/or other input/output mechanisms. In some embodiments, a display may refer to display on a screen, on a wall, on glasses (e.g., near-eye-display), in the air, etc. The user interface 28 may also be in communication with the memory 24 and/or the communication interface 26, such as via a bus.

The communication interface 26 may facilitate communication between different user devices and/or between the processing server 12 and user device 10. The communications interface 26 may be capable of operating in accordance with various first generation (1G), second generation (2G), 2.5G, third-generation (3G) communication protocols, fourth-generation (4G) communication protocols, fifth-generation (5G) communication protocols, Internet Protocol Multimedia Subsystem (IMS) communication protocols (e.g., session initiation protocol (SIP)), and/or the like. For example, a mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like.

The apparatus 20 of example embodiments, particularly when embodying a mobile user device, may further include one or more sensors 30 which may include location sensors, such as global positioning system (GPS) sensors, sensors to detect wireless signals for wireless signal fingerprinting, sensors to identify an environment of the apparatus 20 such as image sensors for identifying a location of the apparatus 20, or any variety of sensors which may provide the apparatus 20 with an indication of location.

While the apparatus 20 is shown and described to correspond to a user device 10, embodiments provided herein may include a user device that may be used for a practical implementation of embodiments of the present disclosure. For example, such an apparatus may include a laptop computer, desktop computer, tablet computer, mobile phone, or the like. Each of which may be capable of providing a graphical user interface (e.g., presented via display or user interface 28) to a user for interaction with a map providing mobility information, navigation information, point of interest information, etc. for geographic regions as described further below. Embodiments of the apparatus may include components similar to those as shown in FIG. 2 through which a user may interact with mobility data presented on the display of a user interface for a device, such as apparatus 20.

Embodiments described herein relate to generating recommendations for POIs using a query context space to measure and quantify recommendations for the POIs. As described above, the query context space includes a multi-dimensional space with the origin being the query, and POIs disposed in the space based on their quantified properties. These quantified properties along each axis place each POI in space a distance from the origin, where the distance reflects the strength of the recommendation. While a three-dimensional space is described herein representing three components of a recommendation measure, any number of components may be used. The query context space does not exist prior to a query as the components of the space are dictated by the query, and thus the query context space is constructed for a specific query. This process does not rely on previously-established defined aspects of a POI, but instead establishes what a query is seeking, and generates components of the query context space from the query itself.

Embodiments described herein provide a recommendation algorithm that uses a constructed query context space. The query context space is not predetermined or set before the recommendation system parses and understands the query. According to an example embodiment, the recommendation system receives a user query then parses and extracts hidden contexts within the query for understanding a user's intent behind the query. The extracted contexts of the query define the query context space. Once the query context space is constructed, the recommendations sytem of example embodimens considers the query as the origin of the space, and POIs are entered into the space based on their relationship with the contexts of the query. The measured distance from the POIs to the query origin of the query context space determines how close the POI is to satisfying what the query is searching for, and thus the strength of the recommendation. A machine learning model parses the query, extracts contexts from the query, constructs the query context space, and presents the POIs as vectors which include context components within the space.

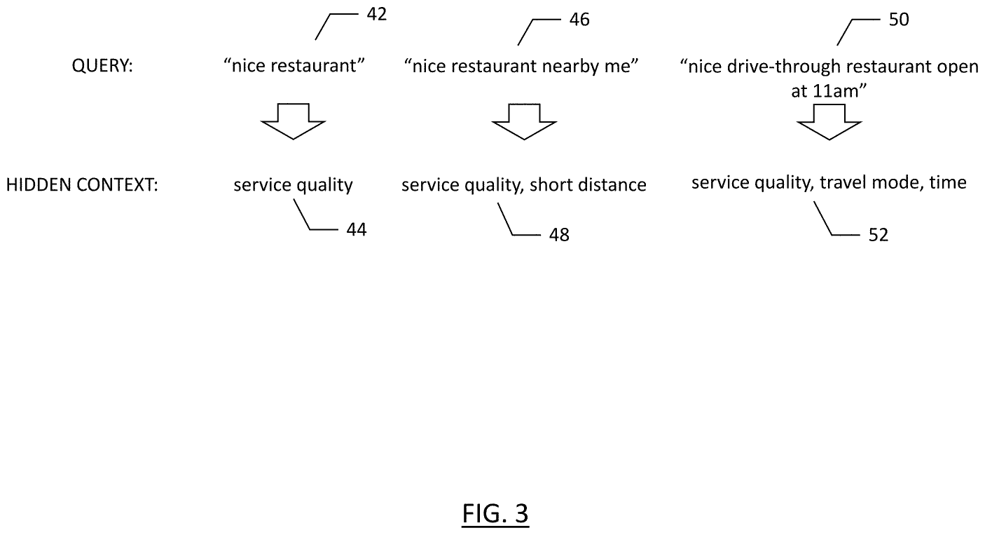

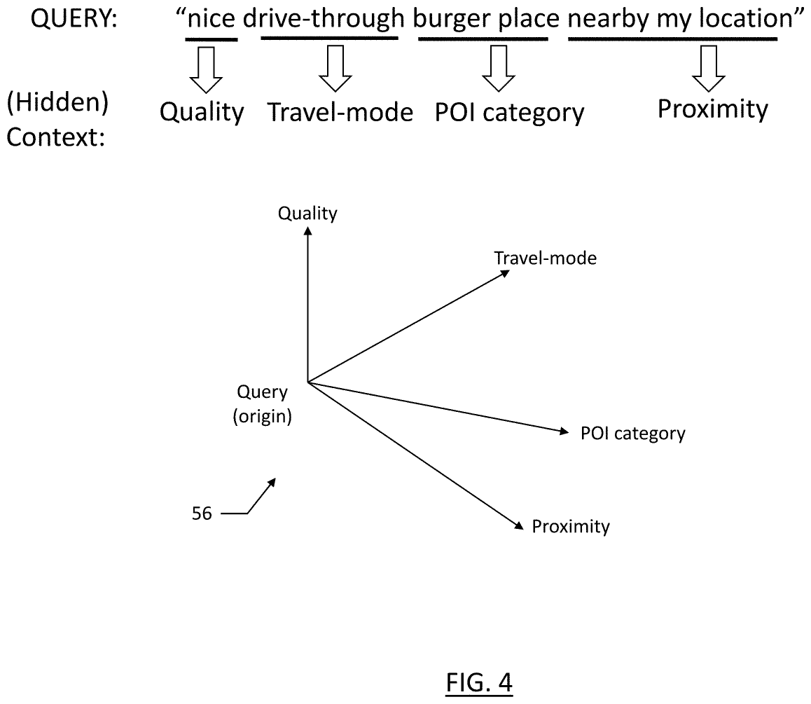

FIG. 3 illustrates an example embodiment of the process for parsing and extracting contexts from queries. As shown, a query including “nice restaurant” 42 can be parsed to extract the term “nice” and interpreted as meaning “service quality” 44 is an important metric for recommendations. The query including “nice restaurant nearby me” 46 indicates that service quality is an important metric, but also a short distance 48 away from a location identified by the person making the query. A query including “nice drive-through restaurant open at 11 am” is parsed and the context extracted includes “service quality, travel mode, time” 48 as the term “nice” is interpreted as “service quality”, “drive through” indicates that the user is arriving by car such that the “travel mode” is known, and the opening time indicates that the user wants to be there near 11 am such that “time” is an important factor. These hidden contexts are used to build the query context space illustrated in FIG. 4.

FIG. 4 illustrates a query including “nice drive-through burger place nearby my location” which is parsed to extract the hidden context. The hidden context of “nice” is translated to “quality”, while “drive-through” indicates travel mode. The query element of “burger place” is translated to a POI category, while “nearby my location” indicates proximity. These four contexts become the components for the query context space that is generated from this query. According to example embodiments, the query context space is not preconstructed as certain contexts may not be relevant and therefore a predetermined space may include factors that are irrelevant to the query. The query context space 56 of FIG. 4 shows the four dimensions of the query context space corresponding to the hidden contexts of the query.

Once the query context space is constructed, POIs can be placed within the space. To rank or sort the recommendation list of POIs, the distance between the query which is the origin of the query context space and each POI is measured. To place a POI in the query context space may require parsing of the POIs as the semantic context of a POI may not be stored in a POI database. The semantic context of a POI of example embodiments is formulated automatically by a machine learning model to represent the semantic definition of the POI that is related to the extracted query context. Natural language processing may be used to establish some semantic context of a POI, while other contextual elements may simply be calculated, such as a distance from a location or a popularity/user rating of a POI. Natural language processing may be used to establish what type of food or ambiance is found at a particular POI, particularly when such information is not explicitly stored in a POI database.

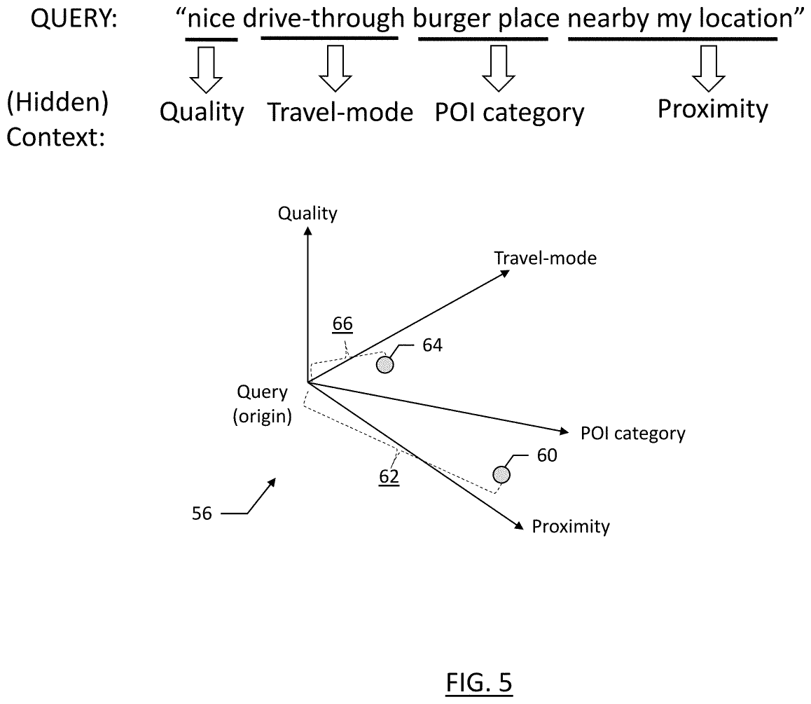

Referring again to the example query of FIG. 4, a query is made using the hidden context extracted from the query to use contexts of “quality”, “travel mode”, “POI category”, and “proximity”. The query may find two recommendable POIs within a predefined distance or boundary from the query location. FIG. 5 illustrates these two POIs mapped to the query context space. The first POI 60 is an American restaurant ten kilometers from the query location, while the second POI 64 is a drive-through burger chain restaurant two kilometers from the query location. A vector representation to be in this space requires four dimensions with each POI vector represented with four elements. According to an example embodiment, elements of the vectors have values between zero and five, with smaller numbers being better as they are closer to the origin or query and satisfy the query better. In such an embodiment, a value of five is the maximum value of the vector element. The maximum value of a vector element is set to normalize all element value ranges. A shorter distance of the POI from the origin results in a higher ranking for recommendations.

In the example embodiment of FIG. 5, the quality of service is rated based on one or more websites that aggregates user reviews. The first POI 60 may have a quality of 2.5/5.0, a travel mode element value of 3.0/5 (the restaurant may not have a drive-through), a POI category of 0.5/5.0 since the restaurant sells burgers, and a proximity element value of 5.0/5.0 since it is ten kilometers away. The second POI 64 may have a quality element value of 2.5/5.0 based on user reviews, a travel mode element value of 0.5/5.0 since it has a drive through, a POI category of 0.5/5.0 since it sells burgers, and a distance element value of 0.5/5.0 as it is within two kilometers. These element values result in a vector for the first POI 60 of [2.5, 3.0, 0.5, 5.0] and for the second POI 64 of [2.5, 0.5, 0.5, 0.5]. This places the second POI 64 closer to the origin than the second POI 60, with a distance to the first POI 60 shown as 62, and a distance to the second POI 64 shown at 66 in FIG. 5. Thus, the second POI 64 is a stronger recommendation than the first POI 60.

The query context space is generated based on the needs of each individual query such that the query space is built on a per-query basis. Embodiments of a query may include basic or default features, such as a semantic similarity to the requested POI category, a popularity or user rating, and a distance from a query location. The default categories may be used when a user enters a query that has little context. For example, if a user enters a query of “burgers”, the recommendation algorithm may look for POIs corresponding to restaurants selling burgers. Though this alone may not be sufficient to rank the recommendations, as several burger chain restaurants would rate the same in terms of POI category. As such, the distance to the query location and the popularity of the POIs may be added to such a query of low context.

The query context space is generated based on a query as queries can be unique and require different contexts to be searched than simple categorical searching on POIs. For example, a query may include “restaurant for today's weather”. In such a query, the weather may be a factor in establishing recommendations. If the weather is sunny and warm, the query may establish that the weather is nice and use the “today's weather” query as having a hidden context of “outdoor dining”. Thus, hidden contexts of queries can be widely varied and when properly interpreted, can provide superior recommendations to existing method for generating recommendations.

The following embodiment describes a query that includes three dimensions representing three contextual elements found in the query context space. As described above, any number of dimensions are possible, and the contexts associated with each dimension may change from query to query, such that the following description represents one such example of a query including three dimensions.

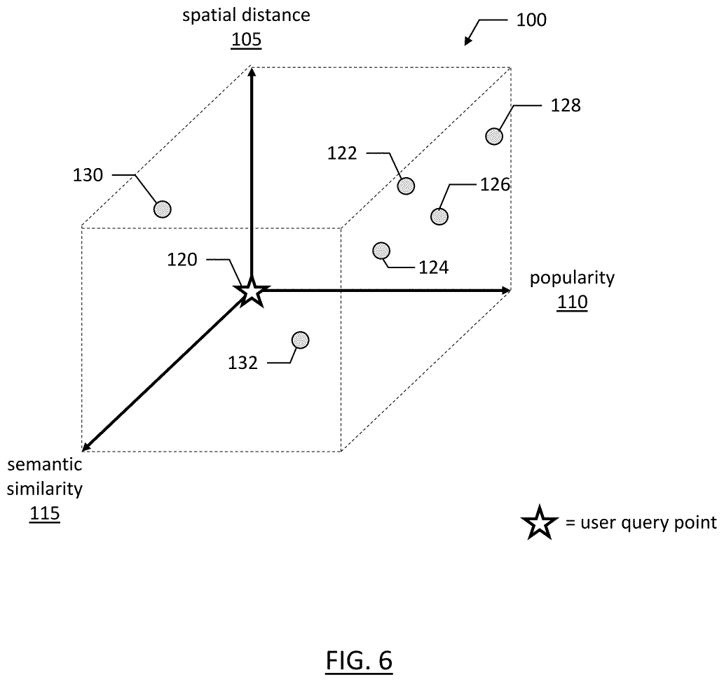

FIG. 6 illustrates an example embodiment of a query context space 100 where a query and recommendable POIs are placed. As shown, the three components include spatial distance 105, popularity 110, and semantic similarity 115. At the origin of the query context space 100 is the user query point 120. The closer a POI is to the user query point 120 in the query context space 100, the closer the recommendation is to the query as measured using the three components of the query context space. Thus, the query is represented as a vector for in three-dimensional query context space is [0,0,0].

POIs in the query context space can similarly be represented as vectors. FIG. 6 illustrates POIs 122, 124, 126, 128, 130, and 132. The representation of the POI vectors in three-dimensional space is described further below. Once a query and all recommendable places are represented as vectors and located in the query context space 100, the distances can be determined between each POI and the query point 120 at the origin. Shorter distances correspond to more suitable recommendations for a POI for the given query.

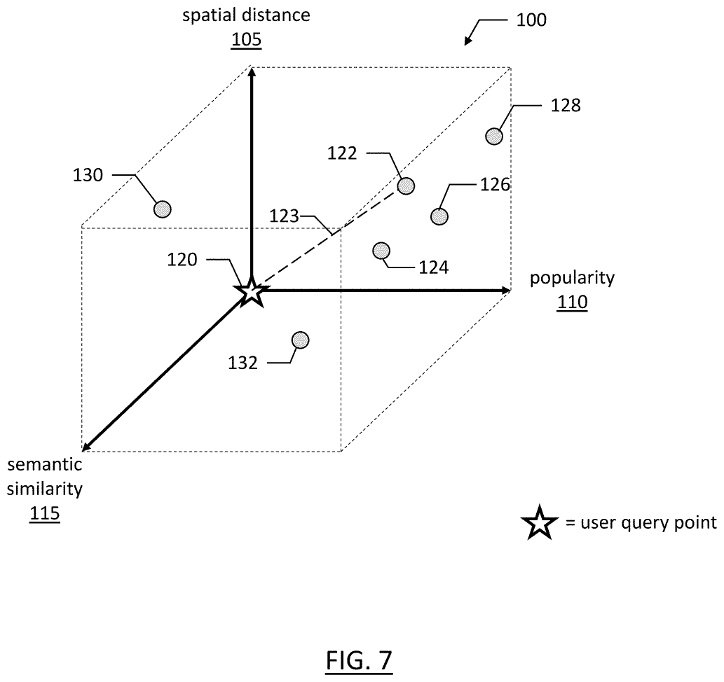

The query context space of example embodiments described herein includes multiple components that can convey contexts in queries and in POIs. By putting query and POIs in the query context space, the contextual relationship between the query and the POIs can be visualized. To measure the contextual relationship quantitively, the query and POIs can be represented in vector format. Each element in the vector is the distance value corresponding to the component. For example, if a place is presented as [0.1, 0.2, 0.3], the semantic similarity distance value is 0.1, the popularity distance value is 0.2, and the spatial distance value is 0.3. The order of these components is not of critical importance; however, it must remain constant for the query context space. Spatial distance value is the physical distance between the POI and the query (origin). The physical distance is normalized to a score to indicate the spatial distance between the query and the POI. FIG. 7 illustrates the query context space 100 with the query as the origin and all POIs in the space, together with a distance 123 to POI 122.

The POI vectors are determined through identification of the measure of the different components. The attribute ‘semantic similarity’ 115 indicates the semantic similarity between the POI and the query. For example, if the query is “Italian restaurant”, a user would have an expectation to have the recommendation include restaurants where Italian cuisine is served or at minimum places that are categorized as restaurants. Any other POI category, for example, schools and parks, would not be semantically similar to the query. The semantic similarity score is measured by vector similarity calculation between query vector and a place description vector. Place names may not be suitable for semantic similarity as many names may not convey sufficient detail regarding a POI.

As place names are often not a good indicator of what the place sells or what service it provides (e.g., a store or restaurant bearing the name of the owner), embodiments described herein use a POI description to establish semantic similarity. The POI description may be stored, for example, in POI database 16. The POI description of example embodiments may include two (or more) parts, including a descriptor in the form of an adjective, and a category in the form of a noun. In a POI database, a POI may include multiple categories and several descriptive terms. For example, a department store may fall into numerous categories, or a restaurant may serve different types of cuisine. Therefore, to select the most suitable descriptor of a POI, the semantic distance may be measured between the POI name and all properties of the POI. For the category or noun portion, the POI name and all listed categories may be measured semantically.

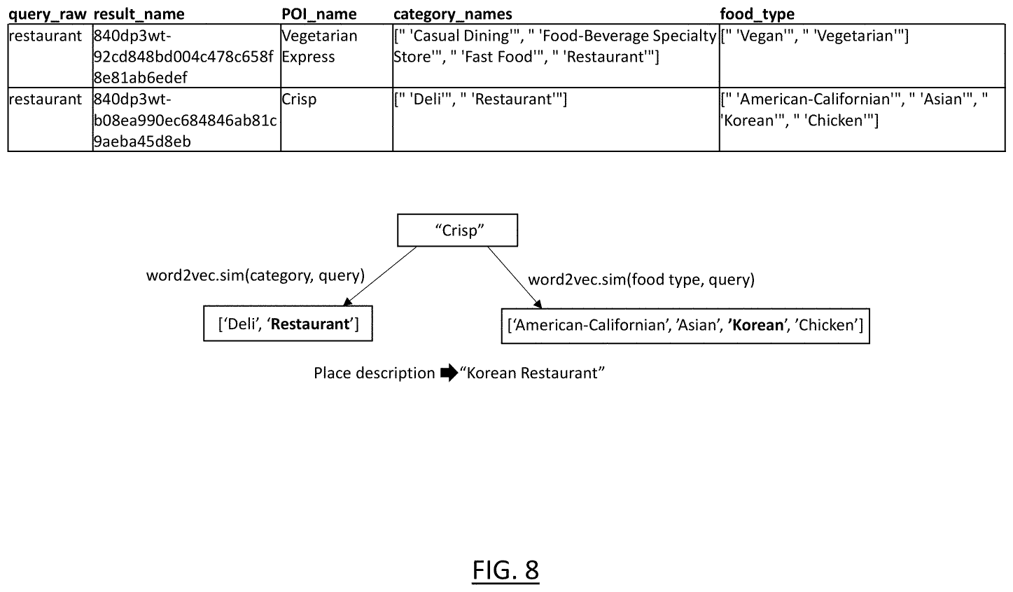

FIG. 8 illustrates POI entries in a POI database with entries having place name, category name, and food type (which is a column specific to restaurants or specialty grocers, for example). One of the POIs in the database of FIG. 8 is a POI having the name “Crisp” that incldues two categories (Deli and Restaurant) and four food types. To find the POI description of POI “Crisp”, the semantic similarity wiht each category is measured and with each food type against the POI name. The most semantically similar category and food type are used to form a description of “Crisp.” As shown, the category of “Restaurant” is deemed more semantically similar, and the food type of “Korean” is deemed more semantically similar to the POI name. As such, according to the example embodiment, the POI descriptor is established as “Korean Restaurant”.

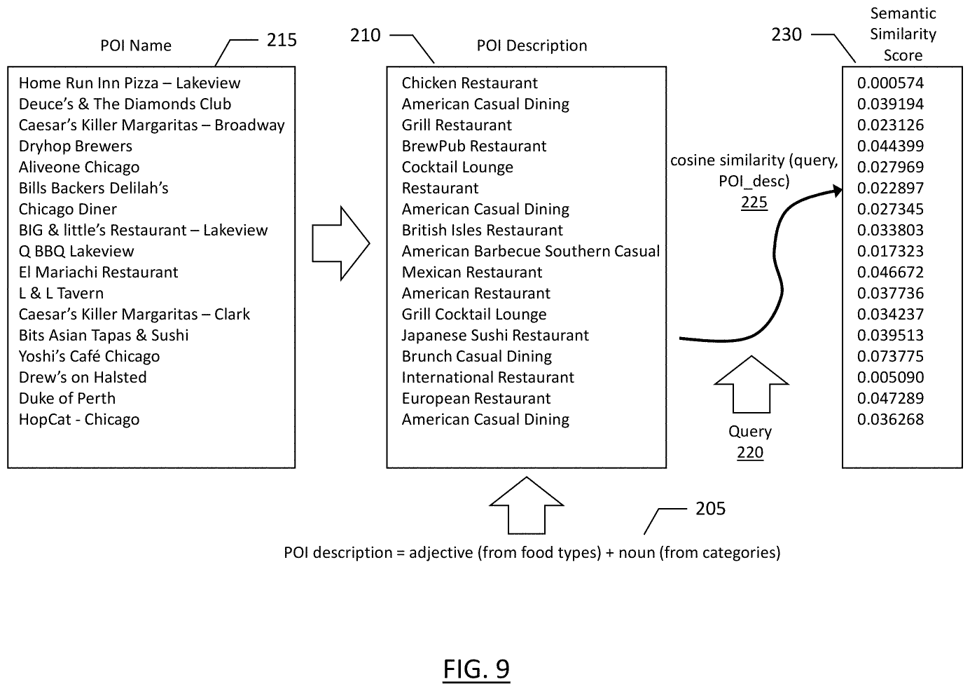

When the description of POIs is determined, both the query and POI description are vectorized using word embedding techniques such as word2vec. The semantic similarity measurement between two vectors are done by cosine similarity calculation. The maximum value of the cosine similarity score is 1.0, and the bigger the score the more semantically similar. In the query context space, the location close to the origin indicates a POI contextually close to the query. Therfefore, the similarity score should be represented as semantic similarity distance. The similarity score is normalized and then converted as semantic similarity value. FIG. 9 illustrates how the similarity score can be measured between the POI description and the query.

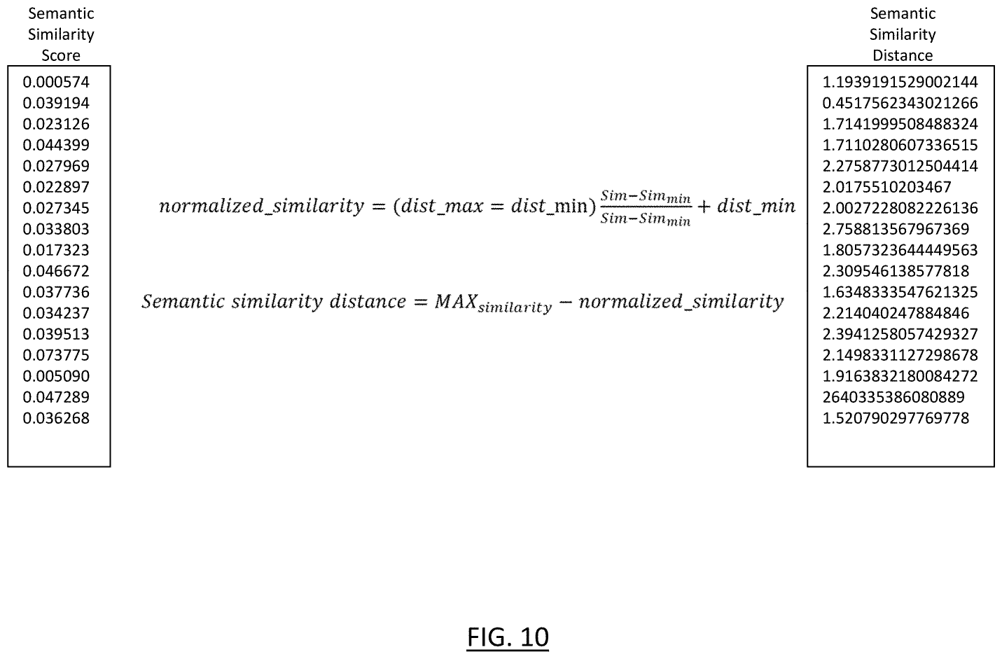

The POI description is established as detailed above at 205 for the POI description 210 in the POI database. The POI name 215 is used, where necessary, to decipher the POI description. The query is input at 220 and used with the POI description finding the cosine similarity at 225 to generate the semantic similarity score at 230. FIG. 10 illustrates how to convert the simliarity score into a similarity distance using normalized similarity and the semantic similarity distance equation.

Referring back to FIG. 6, the second component or attribute is “popularity” 110. The popularity component indicates how a POI is known and rated by users. The value of the popularity component is measured by averaged rating of given places and converted to a distance score. The source of the POI ratings can be various and can be aggregated or considered from individual sources determined to be reliable. Established or known review websites and apps can be used to obtain user ratings for a POI, and the number of ratings can be used to weight the ratings provided by any particular source. Typically, a higher rating for a POI reflects a greater user satisfaction from their experience at the POI, whether it is a restaurant, store, tourist attraction, service, etc. The popularity value that is calculated from reviews can be converted to a popularity distance such that in the query context space the shorter the popularity distance reflects a higher popularity score.

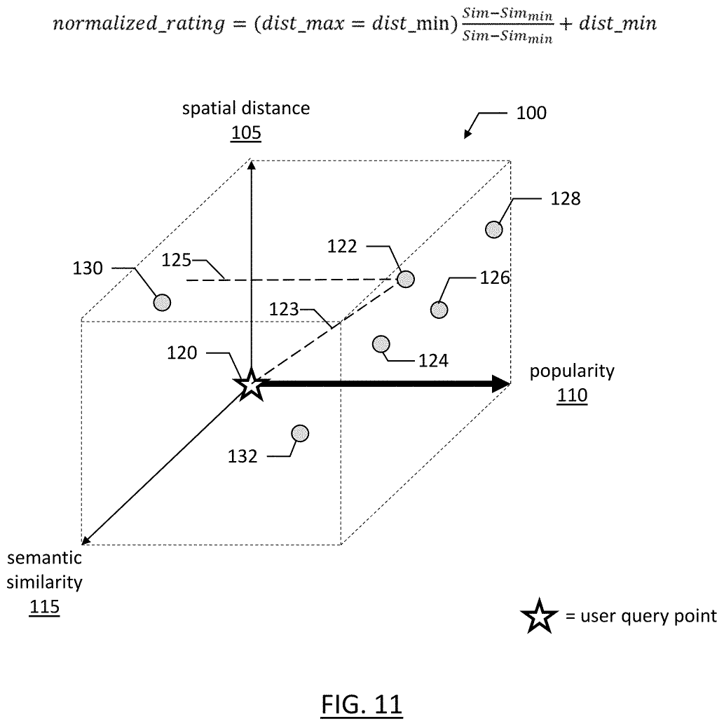

FIG. 11 illustrates how popularity distance can be calculated based on a popularity rating of a POI. Popularity ratings and user reviews are gathered from one or more sources and may be weighted based on reliability of the source and/or the number of ratings from a source. The ratings are normalized into values of a range distance min=0.0, distance max=5.0. The equation of FIG. 11 is used to determine the normalized rating. The normalized rating is inverted with the normalized rating subtracted from the maximum rating, which renders a high rating equating to a low distance in the query context space. The inversed rate values are averaged for a POI (and weighted if necessary) to obtain an inverted normalized rating that becomse the popularity distance. As shown in FIG. 11, the popularity distance component 125 of POI 122 is shown as a distance to the POI 122 orthogonal to the plane defined by the spatial distance 105 axis and the semantic similarity 115 axis. This popularity distance 125 reflects the popularity component of the distance of POI 122 from the query 120 origin.

The third component of the query context space 100 of the example embodiment described above is the spatial distance component or attribute is the normalized distance between the query location to the POI location. Instead of using the actual physical distance, the normalized value can be the spatial distance value. The spatial distance will be correlate to the physical distance between the POI location and the query. If a query includes a location of the search (e.g., a location of user device 10, or a location selected by a user), a point of interest with a very short physical distance to the query location would be similarly very close to the origin of the query context space 100.

According to some embodiments, the spatial distance component can be weighted dependent upon the distances to the respective POIs. For example, in a rural area or a region less-populated with the type of POI of the query, distance may be less important to a recommendation since the availability of such POIs may be limited. Therefore, the spatial distance component may be POI density dependent in some embodiments. Further, the POIs considered for the query context space may be limited on each component. For example, a spatial distance beyond a predetermined physical distance may be too great to be considered, even if other components of a POI beyond this physical distance are relatively close to the query. For example, a POI that is both very popular and very semantically similar to the query, but is very far away from the location associated with the query may be excluded due to the distance being too great. This distance may be a physical distance (e.g., “as the crow flies” or a driven distance along roadways), or the distance could be measured in travel time. Similarly, if a semantic similarity is too dissimilar from a query, the POI may not be considered. For example, if a person is looking for a restaurant serving breakfast, a restaurant only open for dinner may be considered too semantically dissimilar to be considered, even if it is close in proximity to the query and very popular.

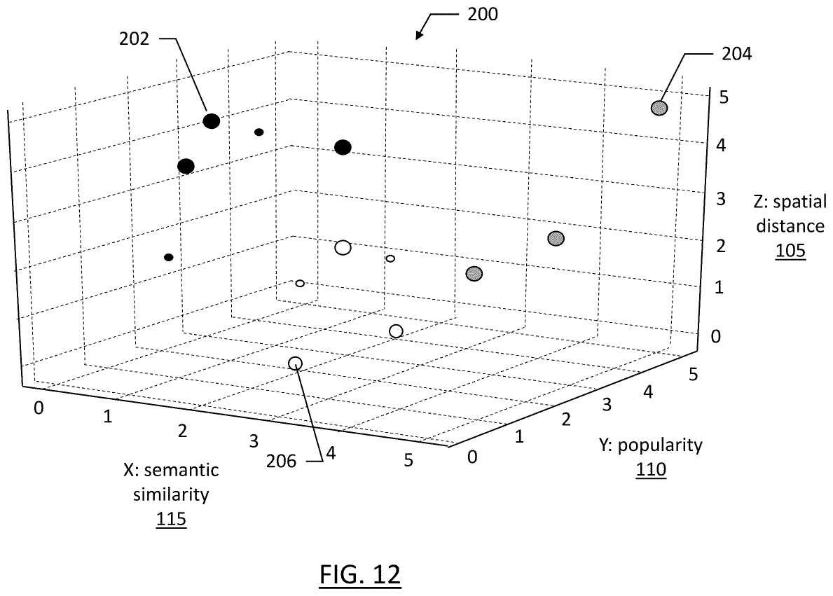

Once the three component values are established for the POIs in the query context space, a measure of the distance between the query and each POI can be determined through vector distance calculation. A ranking of the recommendations for POIs can be determined by the distance between the query (origin, query vector) and the POI (POI vector). According to an example embodiment, a location is selected, such as the location of a mobile device or a specific location selected by a user. This location may be a point location (e.g., latitude and longitude), or may be a bounded area (e.g., a city, a postal code, a drawn boundary, etc.). A query is entered by the user, such as “museum”, whereby a query is conducted for the POIs that satisfy the query by location and POI descriptor. FIG. 12 illustrates a result of such an example query, where the recommendable POIs are represented as vectors and placed in the query context space 200.

FIG. 12 further illustrates clustering of the recommendable POIs through Gaussian Mixture Model clustering, represented by different shading. For example, a first cluster shown in dark shading such as POI 202, a second cluster shown in medium shading such as POI 204, and a third cluster shown without shading such as POI 206. These clusters may represent POIs having a similar distance to the query origin, indicating that they are of similar recommendation scores. This may be used to create “tiers” of recommendations, where a first tier is within a first distance of the query, while a second tier is further from the query origin. Tiers may be used to establish what recommendations to present to a user. For example, only POIs in a first tier may be presented to a user for conciseness in a crowded field of recommendations.

The recommendations presented to a user may be established based on user preferences or based on settings of an application configured to present recommendations. For example, a navigation user interface of a vehicle may present only a limited number of top recommendations as such information may need to be presented in an easily intelligible and quickly read format. A user interface on a device with a relatively larger display, such as a tablet or laptop computer, may present a larger number of recommendations due to the size of the display and the ability of a user to interact with greater freedom with the results. The recommendations may be presented in ranked order of distance to the query origin, where the closer a POI vector is to the query origin, the higher ranked the recommendation for that POI.

Embodiments described herein to generating recommendations for POIs using a query context space can be further configured by a user to provide better recommendations for a specific user. For example, a user who does not want to travel by vehicle to a POI may value physical distance proximity over popularity or semantic similarity. In such an embodiment, the user may more heavily weight spatial distance. To do this using the query context space, the scale of the spatial distance axis may change by a percentage or a scaling factor that brings brings POIs closer to the origin along the spatial distance axis while maintaining the scale of the other axes. According to another example embodiment, a user may be more concerned with popularity or user-rating of a POI over distance or semantic similarity. In such an embodiment, the scale of the popularity index may be altered by a scaling factor that functions as a weighting factor to more heavily weight popularity. Further, multiple components can be weighted with either greater weight or less weight using such scaling factors.

Embodiments may be adaptable to learn a user's preferences and to use that learning to provide better recommendations tailored for the user. Embodiments may determine which recommendation a user selects, such as when the user requests directions to a POI or requests additional information. Optionally, in the case of a mobile device, a location of the user may be used to determine which POI the user has selected. When a user selects a POI, particularly when the selected POI is not the closest result to the query, embodiments may learn preferences of the user. For example, if a user selects a restaurant that is further from the query in the query context space, embodiments can determine what differences the selected POI has over the POIs that were closer to the query origin. If a user consistently selects a POI, such as a restaurant, with a higher user rating, embodiments can determine that user rating is important to the user, and weight user rating higher accordingly to bring such POI recommendations closer to the user query. These learned factors can lead to a query context space for a user that is dialed in to the user's preferences without requiring the user to select category weights.

Embodiments described herein use linear computation to represeent query and places as vectors. The distance computation time is relatively inexpensive, such that embodiments can quickly process results of a query even when there are many POIs in the results. Further, the query context space is extendable. While the aforementioned embodiments use three components (semantic similarity, popularity, and spatial distance), other components or attributes may be included. Such attributes may include travel time (walking time, driving time, parking time, etc.), social context (e.g., business or leisure), and personal preference factors to name a few.

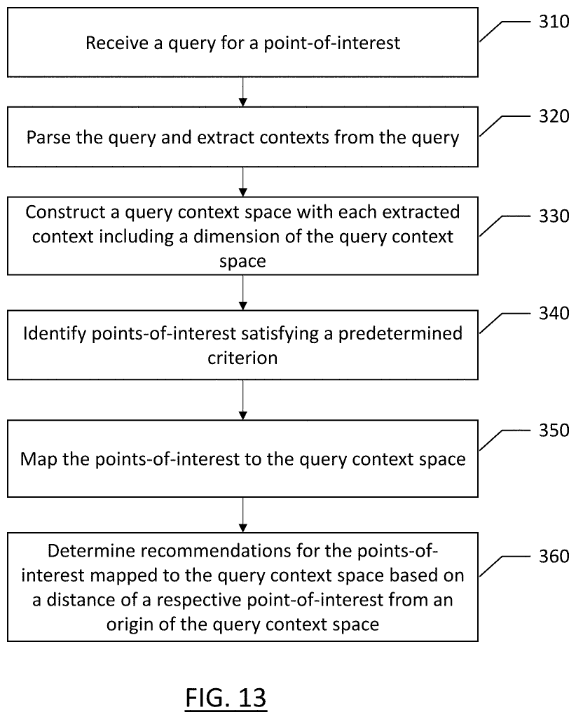

FIG. 13 illustrates a flowchart of a method for generating and using a query context space to measure and quantify recommendations for points-of-interest. As shown at 310, a query is received for a point-of-interest. This query may be received, for example, from a user device 10 at a service provider 11. The query is parsed at 320 and contexts are extracted from the query. Contexts include clues to what the query is searching for, and may include any terms that describe a target of the query. A query context space is constructed at 330 with each extracted context as a dimension of the query context space. Points-of-interest are identified that satisfy at least one predetermined criterion at 340. This serves to narrow down the points-of-interest from all available points-of-interest to those, for example, within a predetermined distance of the location associated with the query. The points-of-interst satisfying the predetermined criterion are mapped to the query context space at 350. Recommendations for the points-of-interest mapped to the query context space are determined at 360 based on a distance of a respective point-of-interest from an origin of the query context space.

As described above, FIG. 13 illustrates a flowchart of apparatuses 20, methods, and computer program products according to an example embodiment of the disclosure. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 24 of an apparatus employing an embodiment of the present invention and executed by the processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the method of FIG. 13 above may comprise a processor (e.g., the processor 22) configured to perform some or each of the operations (310-360) described above. The processor may, for example, be configured to perform the operations (310-360) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 310-360 may comprise, for example, the processor 22 and/or a device or circuit for executing instructions or executing an algorithm for processing information as described above.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to at least:
receive a query for point-of-interest recommendations;
parse the query and extract contexts from the query;
construct a query context space with each extracted context comprising a dimension of the query context space;
identify points-of-interest satisfying a predetermined criterion;
map the points-of-interest to the query context space; and
determine recommendations for the points-of-interest mapped to the query context space based on a distance of a respective point-of-interest from an origin of the query context space.

2. The apparatus of claim 1, wherein the apparatus is further caused to provide for display of a list of recommendations for the points-of-interest mapped to the query context space ranked from closest to the origin of the query context space to furthest from the origin.

3. The apparatus of claim 1, wherein the predetermined criterion comprises at least one of a predefined boundary or a predefined distance from a location associated with the query.

4. The apparatus of claim 1, wherein causing the apparatus to parse and extract contexts from the query comprises causing the apparatus to process the query using a machine learning algorithm to extract contexts from the query.

5. The apparatus of claim 1, wherein the extracted contexts from the query comprise a semantic similarity, a distance from a location associated with the query, and a rating.

6. The apparatus of claim 5, wherein causing the apparatus to map the points-of-interest to the query context space comprises causing the apparatus to:
determine, for each identified point-of-interest, a semantic similarity to the query;
determine, for each identified point-of-interest, a distance to the location assocaited with the query; and
determine, for each identified point-of-interest, a rating.

7. The apparatus of claim 6, wherein causing the apparatus to map the points-of-interest to the query context space further comprises causing the apparatus to:
calculate a vector for each point-of-interest based on the respective semantic similarity, the distance, and the rating; and
determine a length of the vector for each point-of-interest.

8. The apparatus of claim 7, wherein causing the apparatus to determine recommendations for the points-of-interest mapped to the query context space based on a distance of a respective point-of-interest from an origin of the query context space comprises causing the apparatus to:
rank the points-of-interest based on the length of the vector for each point-of-interest, wherein a shorter length of the vector corresponds to a higher ranking.

9. A computer program product comprising at least one non-transitory computer-readable storage medium having computer-executable program code instructions stored therein, the computer-executable program code instructions comprising program code instructions to:
receive a query for a point-of-interest;
parse the query and extract contexts from the query;
construct a query context space with each extracted context comprising a dimension of the query context space;
identify points-of-interest satisfying a predetermined criterion;
map the points-of-interest to the query context space; and
determine recommendations for the points-of-interest mapped to the query context space based on a distance of a respective point-of-interest from an origin of the query context space.

10. The computer program product of claim 9, further comprising program code instructions to: provide for display of a list of recommendations for the points-of-interest mapped to the query context space ranked from closest to the origin of the query context space to furthest from the origin.

11. The computer program product of claim 9, wherein the predetermined criterion comprises at least one of a predefined boundary or a predefined distance from a location associated with the query.

12. The computer program product of claim 9, wherein the program code instructions to parse and extract contexts from the query comprise program code instructions to process the query using a machine learning algorithm to extract contexts from the query.

13. The computer program product of claim 9, wherein the extracted contexts from the query comprise a semantic similarity, a distance from a location associated with the query, and a rating.

14. The computer program product of claim 13, wherein the program code instructions to map the points-of-interest to the query context space comprise program code instructions to:
determine, for each identified point-of-interest, a semantic similarity to the query;
determine, for each identified point-of-interest, a distance to the location assocaited with the query; and
determine, for each identified point-of-interest, a rating.

15. The computer program product of claim 14, wherein the program code instructions to map the points-of-interest to the query context space comprise program code instructions to:
calculate a vector for each point-of-interest based on the respective semantic similarity, the distance, and the rating; and
determine a length of the vector for each point-of-interest.

16. The computer program product of claim 15, wherein causing the apparatus to determine recommendations for the points-of-interest mapped to the query context space based on a distance of a respective point-of-interest from an origin of the query context space comprise program code instructions to:
rank the points-of-interest based on the length of the vector for each point-of-interest, wherein a shorter length of the vector corresponds to a higher ranking.

17. A method comprising:
receiving a query for a point-of-interest;
parsing the query and extracting contexts from the query;
constructing a query context space with each extracted context comprising a dimension of the query context space;
identifying points-of-interest satisfying a predetermined criterion;
mapping the points-of-interest to the query context space; and
determining recommendations for the points-of-interest mapped to the query context space based on a distance of a respective point-of-interest from an origin of the query context space.

18. The method of claim 17, further comprising providing for display of a list of recommendations for the points-of-interest mapped to the query context space ranked from closest to the origin of the query context space to furthest from the origin.

19. The method of claim 17, wherein the predetermined criterion comprises at least one of a predefined boundary or a predefined distance from a location associated with the query.

20. The method of claim 17, wherein parsing and extracting contexts from the query comprises processing the query using a machine learning algorithm to extract contexts from the query.
